(19) United States
(12) Patent Application Publication
(10) Pub. No.: US 2015/0256584 A1
(43) Pub. Date: Sep. 10, 2015

(54) SYNCHRONOUS TRANSMISSION SERVER

(71) Applicant: Mitsubishi Electric Corporation, Chiyoda-ku, Tokyo (JP)

(72) Inventors: Hiroki Sakaguchi, Chiyoda-ku (JP); Takehiko Hanada, Chiyoda-ku (JP); Takumi Akiyama, Chiyoda-ku (JP); Shin Miura, Chiyoda-ku (JP)

(73) Assignee: Mitsubishi Electric Corporation, Chiyoda-ku, Tokyo (JP)

(21) Appl. No.: 14/417,626

(22) PCT Filed: Aug. 13, 2013
(86) PCT No.: PCT/JP2013/071878

§ 371 Date: Jan. 27, 2015

(30) Foreign Application Priority Data
Aug. 23, 2012 (JP) 2012-184157

(51) Int. Cl. H04L 29/06

(52) U.S. Cl. CPC H04L 65/607; H04L 65/4084

(57) ABSTRACT

A content list manager is configured to manage a list of contents to be transmitted to the DLNA client as a content list. A stream transmission controller is configured to transmit a content stream in response to a request from the DLNA client for the content stream. Under the transmission status managed by a transmission status manager, when the requested content stream is not being transmitted to another DLNA client, the content list manager registers into the content list as a content for synchronization.

### TECHNICAL FIELD

The present invention relates to devices which support Digital Living Network Alliance (hereinafter referred to as “DLNA”) complying with DLNA standards, specifically, a synchronous transmission server for performing synchronous transmission from a DLNA server device to DLNA client devices.

Today, the DLNA standards do not specify synchronous transmission of storable contents, where identical contents are transmitted from a DLNA server to DLNA clients. Furthermore, such synchronous transmission has not been achieved with existing devices. The synchronous transmission to which the present invention is directed refers to a way that a DLNA server synchronously transmits identical contents to a plurality of DLNA clients. The DLNA server is unable to switch between synchronization and asynchronization depending on a request from a DLNA client with respect to the transmission of identical contents.

Meanwhile, outside the DLNA standards, a mechanism for performing synchronous transmission is disclosed (see, for example, Patent Literature 1). However, a server and clients are designed exclusively, and association with the DLNA standards is not disclosed. Hence, in such a system, mutual connectivity with a device supporting the existing DLNA standards may be lost.

Patent Literature 1: JP 2011-023992 A

### SUMMARY OF INVENTION

According to the existing synchronous transmission server complying with the DLNA standards, synchronous transmission of identical contents to DLNA clients has not been achieved. Furthermore, although non-DLNA standards synchronous transmission is achieved, mutual connectivity with a device supporting the existing DLNA standards may be lost.

The present invention has been made in view of the foregoing circumstances, in order to achieve a synchronous transmission server that does not deviate from the DLNA standards while dispensing with addition of a function to existing DLNA clients.

According to the present invention, there is provided a synchronous transmission server which communicates with a DLNA client in compliance with DLNA standards, the synchronous transmission server including: a content list manager that manages a list of contents to be transmitted to the DLNA client as a content list; a stream transmission controller that transmits a content stream in response to a request from the DLNA client for the content stream; and a transmission status manager that manages the content being transmitted and the DLNA client of a transmission destination by correlating with each other, wherein, when the stream transmission controller receives the request from the DLNA client for the content stream and the transmission status manager recognizes that the requested content stream is not being transmitted to another DLNA client, the content list manager registers into the content list as a content for synchronization.

The synchronous transmission server according to the present invention is configured such that, when the stream transmission controller receives the request from the DLNA client for the content stream and the transmission status manager recognizes that the requested content stream is not being transmitted to another DLNA client, the content list manager registers into the content list as a content for synchronization. Therefore, synchronous transmission can be achieved without deviating from the DLNA standards and also without adding a function to the existing DLNA clients.

### BRIEF DESCRIPTION OF DRAWINGS

FIG. 1 is a configuration diagram depicting a synchronous transmission system including a synchronous transmission server according to Embodiment 1 of the present invention.

FIG. 2 is an explanatory diagram representing a procedure of transmitting a content list in the synchronous transmission system according to the Embodiment 1 of the present invention.

FIG. 3. is an explanatory diagram representing a procedure of updating a content list in the synchronous transmission system according to the Embodiment 1 of the present invention.

FIG. 4 is an explanatory diagram representing a procedure of transmitting a content stream when transmission is not in process to any connection device in the synchronous transmission system according to the Embodiment 1 of the present invention.

FIG. 5 is an explanatory diagram representing a procedure of transmitting a content stream when transmission is in process to another connection device in the synchronous transmission system according to the Embodiment 1 of the present invention.

FIG. 6 is an explanatory diagram representing a procedure of transmitting a content in the synchronous transmission system according to the Embodiment 1 of the present invention.

FIG. 7 is a configuration diagram depicting a synchronous transmission system according to Embodiment 2 of the present invention.

FIG. 8 is a configuration diagram depicting a synchronous transmission system according to Embodiment 3 of the present invention.

FIG. 9 is a configuration diagram depicting a synchronous transmission system according to Embodiment 4 of the present invention.

FIG. 10 is a configuration diagram depicting a synchronous transmission system according to Embodiment 5 of the present invention.

### DESCRIPTION OF EMBODIMENTS

Embodiments of the present invention are described with reference to the accompanying drawings to describe the present invention in further detail.

### Embodiment 1

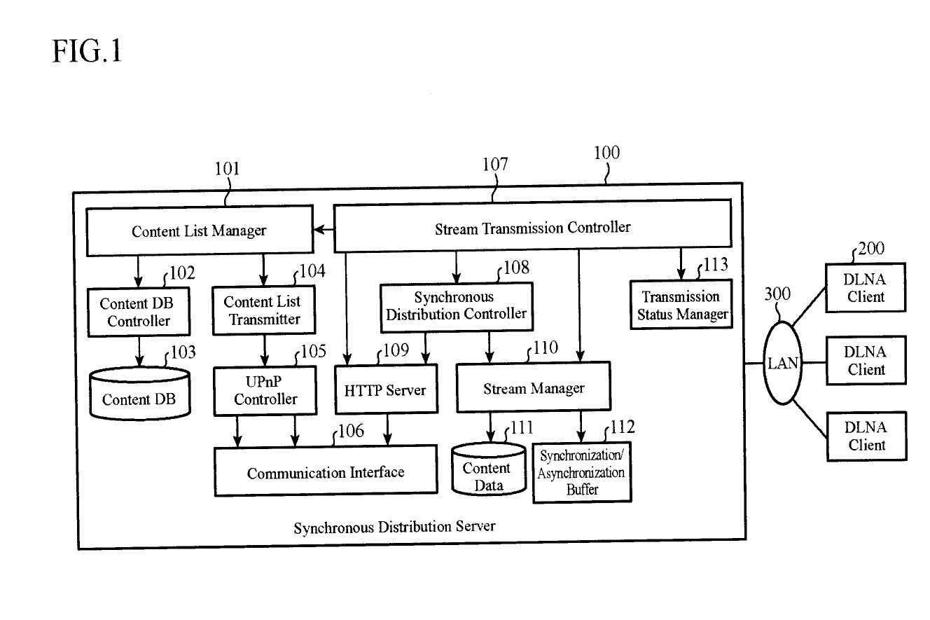

FIG. 1 is a configuration diagram depicting a synchronous transmission system including a synchronous transmission server according to Embodiment 1 of the present invention.

A synchronous transmission server 100 depicted in FIG. 1 includes a content list manager 101, a content DB controller 102, a content database (content DB) 103, a content list transmitter 104, a UPnP controller 105, a communication interface 106, a stream transmission controller 107, a synchronous transmission controller 108, an HTTP server 109, a stream manager 110, a content data 111, a synchronization/asynchronization buffer 112, and a transmission status manager 113. The synchronous transmission server 100 is connected with DLNA clients 200 through a LAN 300. The synchronous transmission server 100 is a device having a function of a digital media server device (DMS) supporting the DLNA standards. Each of the DLNA clients 200 is a DLNA media player (DMP) complying with the DLNA standards. The DLNA standards is a mutual connection system standard for devices connected to home networks (home LANs) and for contents.

The content list manager 101 in the synchronous transmission server 100 is configured to manage lists of contents to be transmitted as content lists. The “contents” comprehensively refer to data of multimedia (e.g., video, still pictures, audio, and characters) that are transmittable from the synchronous transmission server 100 to the DLNA clients 200, and information correlated therewith. The “content lists” refer to lists of contents that are transmittable from the synchronous transmission server 100 to the DLNA clients 200, and also to data storing the lists. The content DB controller 102 is configured to control the content database 103 and to process requests from the content list manager 101 for acquisition of attribute information of transmittable contents. The content database 103 is configured to store contents to be transmitted as records.

The content list transmitter 104 is configured to transmit content lists managed by the content list manager 101. The UPnP controller 105 is configured to achieve the UPnP (Universal Plug and Play) function, which is technical specifications for connecting devices such as home computers and peripheral devices thereof, audio/video devices, telephones, and home appliances to networks and having functions mutually provided thereamong. The communication interface 106 serves as an interface of the synchronous transmission server 100, which is used for sending and receiving data in response to requests from the HTTP server 109 or the UPnP controller 105. The stream transmission controller 107 is configured to transmit content streams. The synchronous transmission controller 108 is configured to control parallel transmission to a plurality of DLNA clients 200. The HTTP server 109 is configured to perform communication with the DLNA clients 200 in accordance with the HTTP specifications. The stream manager 110 is configured to manage the content data 111 and the synchronization/asynchronization buffer 112 by correlating with each other. The transmission status manager 113 is configured to manage the status of the transmission by correlating a content being transmitted with information of a DLNA client 200 of a transmission destination.

Each of the DLNA clients 200 are a device having a function of a digital media player device supporting the DLNA standards. The LAN 300 is a Local Area Network that establishes a home network.

Next, description is given of an operation of a synchronous transmission system thus configured. The disclosure of the present system is roughly classified into transmission of content lists and stream transmission of contents. Description of individual transmission is given below.

### (Transmission of Content List)

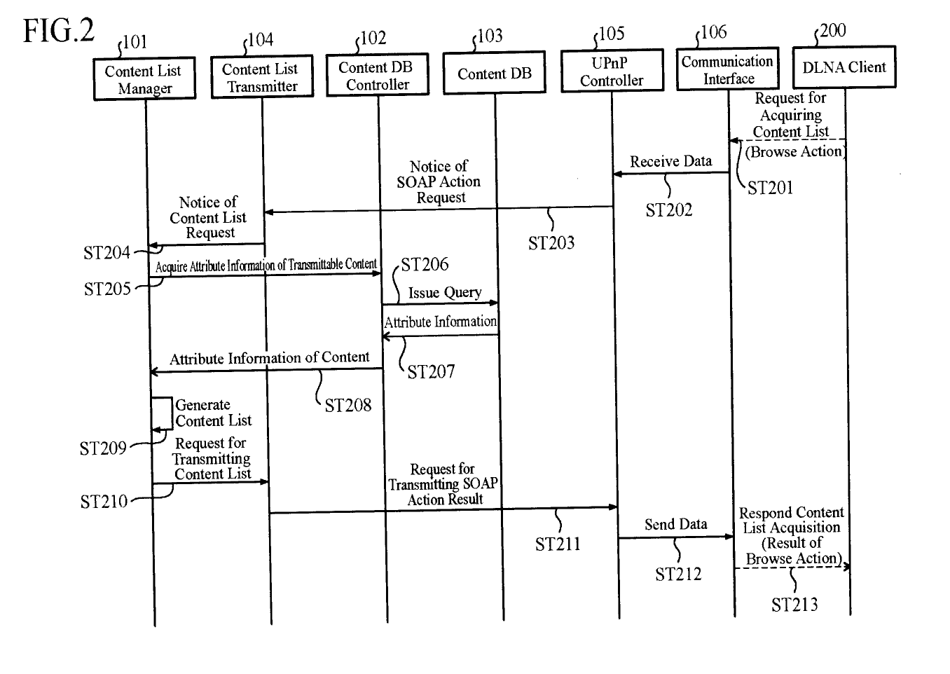

The content list manager 101 sends a list of transmittable contents (i.e. a content list) in response to a request from a DLNA client 200. A procedure for transmitting a content list is described below. Each process of the procedure is illustrated in FIG. 2.

### (Procedure 1)

The content list manager 101 receives a request from a DLNA client 200 (a SOAP Browse action; steps ST201 and ST202) for acquisition of a content list by using the content list transmitter 104 and the UPnP controller 105 (steps ST203 and ST204). The SOAP is a communication protocol based on, for example, XML and HTTP used for calling data or services provided in other computers.

### (Procedure 2)

The content list manager 101 makes a request to the content DB controller 102 for acquisition of attribute information (described later) of a transmittable content (step ST205).

### (Procedure 3)

The content DB controller 102 issues a query to the content database 103 (step ST206), and acquires the attribute information (step ST207). The content DB controller 102 supplies the content list manager 101 with the attribute information of the content, which is contained in the records of the database (step ST208).

### (Procedure 4)

The content list manager 101 generates a content list by using the acquired attribute information (step ST209). The content list to be generated at this time consists of transmittable contents of the contents registered by the content DB controller 102 in the content database 103.

### (Procedure 5)

The content list manager 101 requests the UPnP controller 105, by using the content list transmitter 104, to send the generated content list as the result of the SOAP action (step ST211).

### (Procedure 6)

The UPnP controller 105 transmits data of the result of the SOAP action to the DLNA client 200 through the communication interface 106 after converting the result of the SOAP action to comply with the UPnP specifications (step ST212).

### (Procedure 7)

The communication interface 106 transmits the data to the DLNA client 200 in accordance with UDP protocol and TCP/IP protocol (step ST213).

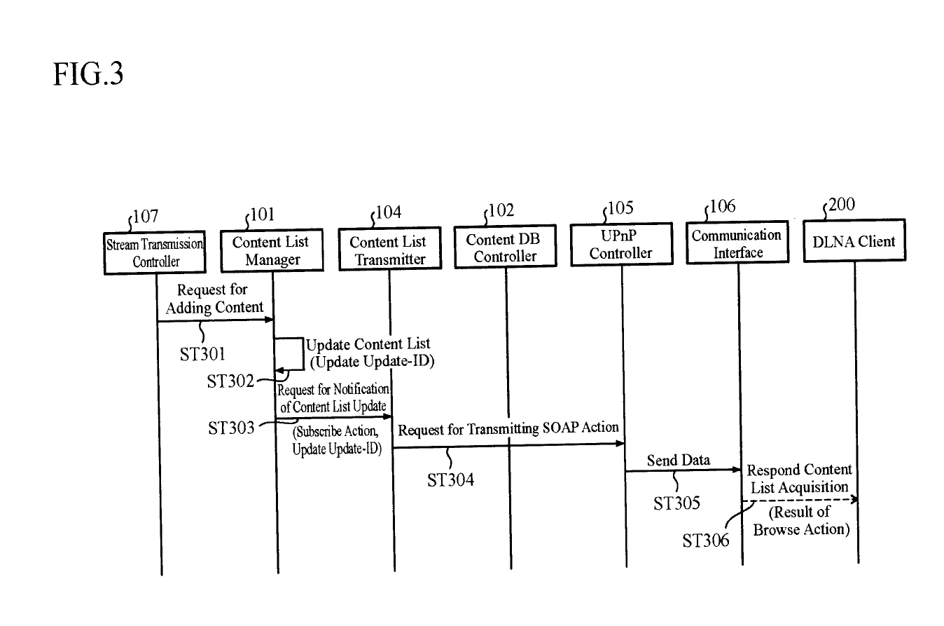

Meanwhile, the content list manager 101 adds a content to be transmitted to the content list based on the designated attribute information in response to a request from the stream transmission controller 107. This procedure is illustrated in FIG. 3.

When the content list manager 101 receives a request from the stream transmission controller 107 for adding a content (step ST301), the content list manager 101 updates the content list (step ST302). The request for addition to a content list can be achieved by using a SOAP Create Object action according to the DLNA standards, or can be provided by the content list manager 101 in the form of a dedicated function. The content list manager 101 notifies the DLNA client 200 of the updating of the content list. The method of notifying updating of a content list can be achieved by updating a content update identifier (an Update ID) that is contained in the result of a SOAP Subscribe action according to the DLNA standards or a SOAP Browse action according to the DLNA standards (steps ST303 to ST306).

### (Attribute Information of Contents)

The content database 103 is configured to store attribute information of contents, and stores at least the following attribute information as records:

Content identifier: An identifier for uniquely identifying a content

Content title: A character string indicating a title of a content (corresponding to “dc:title element” of the DLNA standards)

### (Transmission of Content Stream)

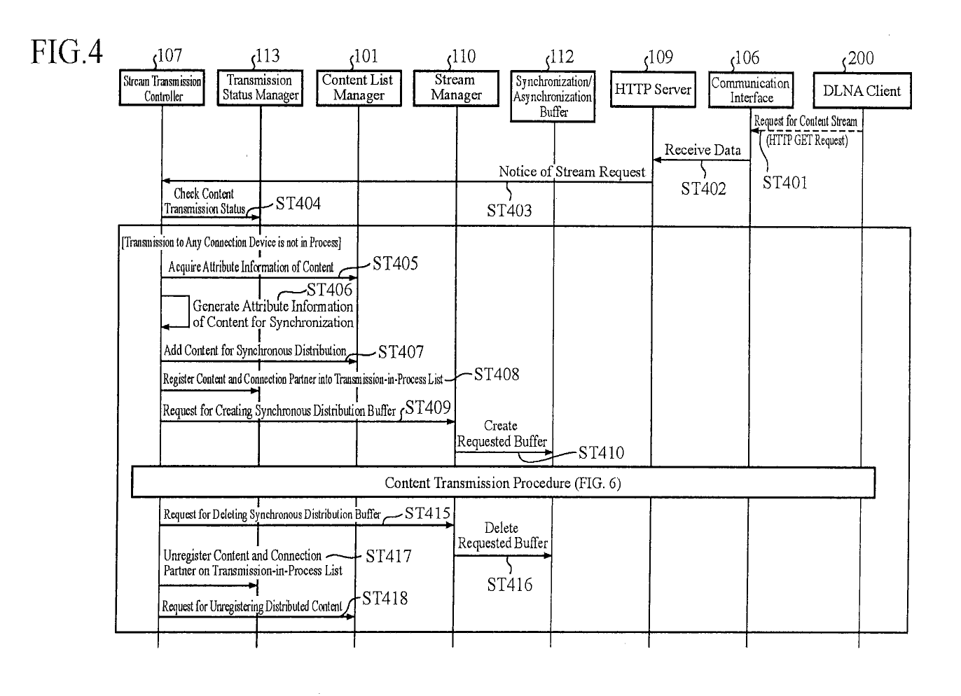

The stream transmission controller 107 controls stream transmission of contents requested from a DLNA client 200 by using the HTTP server 109, the synchronous transmission controller 108, and the stream manager 110. A specific procedure is described below. The procedure is illustrated in FIGS. 4, 5, and 6.

### (Procedure 1) Accept an HTTP Request

The stream transmission controller 107 accepts a request from a DLNA client 200 for reception of a stream of a content (an HTTP request with method=“GET”) by using the communication interface 106 and the HTTP server 109 (FIG. 4, steps ST401, ST402, and ST403). At this time, an identifier for identifying the content is extracted from the URI described in the HTTP request. The identifier is the same as the one contained in the earlier described attribute information of the content. Specific exemplary extracting methods include, for example, a method where a content identifier is extracted at the time of receiving the HTTP request by generating a URL contained in meta data of the content (the value of “res” element) based on the content identifier contained in the attribute information of the content.

### (Procedure 2) Check the Transmission Status

By using the identifier retained in the above “Procedure 1” as a key, the stream transmission controller 107 inquires of the transmission status manager 113 whether the content requested by the DLNA client 200 is being transmitted (FIG. 4, step ST404).

### (Procedure 3) Start Transmission of a Stream

The stream transmission controller 107 requests for the process of transmitting a stream with respect to the DLNA client 200 based on the result of the above Procedure 2. The operation where transmission is not in process is described in (A) shown below, and the operation where transmission is in process is described in (B) shown below.

### (A) Transmission Not in Process

The stream transmission controller 107 acquires the attribute information of the content from the content list manager 101 by using the identifier as a key extracted from the HTTP request and retained in Procedure 1 (FIG. 4, step ST405). The stream transmission controller 107 generates the attribute information described later as a content for synchronous transmission based on the acquired attribute information of the content (FIG. 4, step ST406), and request the content list manager 101 to add the generated information as the content for synchronous transmission to the content list (FIG. 4, step ST407).

As the attribute information of the content for synchronous transmission, the attribute information of the content, which has been acquired in step ST405, is duplicated, and a character string (for example, “Sync”) is added, which can be identified as the one for synchronization of a top and an end of a content title. Herein, a length of the added character string is needed not to exceed the maximum length of the “dc:title” element defined by the DLNA standards.

A content for synchronization is added besides the content having originally existed to the content list managed by the content list manager 101. As a result, two of identical contents, i.e., one for synchronization and one for asynchronization, are to be included.

Subsequently, the stream transmission controller 107 requests the transmission status manager 113 to correlate the connection information described later with respect to the DLNA client 200 as a transmission source of the HTTP request, with the identifier of the content being transmitted so as to be registered as the content being transmitted (FIG. 4, step ST408). The connection information with respect to the DLNA client 200 includes a MAC address, an IP address, and a character string comprising the Server header value when the HTTP request message contains a Server header.

The stream transmission controller 107 requests the stream manager 110 to create the synchronization buffer 112 (FIG. 4, steps ST409 and ST410).

The stream transmission controller 107 performs a process of transmitting a stream. With respect to this process, description is given in “Stream transmitting process” in “Procedure 4” described later.

Upon completion of the stream transmission, the stream transmission controller 107 requests the stream manager 110 to delete the synchronization buffer 112 (FIG. 4, step ST415). The stream manager 110 deletes the synchronization buffer 112 (FIG. 4, step ST416).

The stream transmission controller 107 notifies the transmission status manager 113 of completion of transmission of the content based on the content identifier and the information of the connection partner, and unregisters the content and the connection partner (FIG. 4, step ST417).

Subsequently, the stream transmission controller 107 requests the content list manager 101 to unregister the content for synchronous transmission (FIG. 4, step ST418).

### (A) Transmission in Process

The stream transmission controller 107 performs the following processes depending on whether the identifier retained in Procedure 1 (Accept an HTTP request) is of a content for synchronization or a content for asynchronization.

### (1) In a Case of a Content for Synchronization

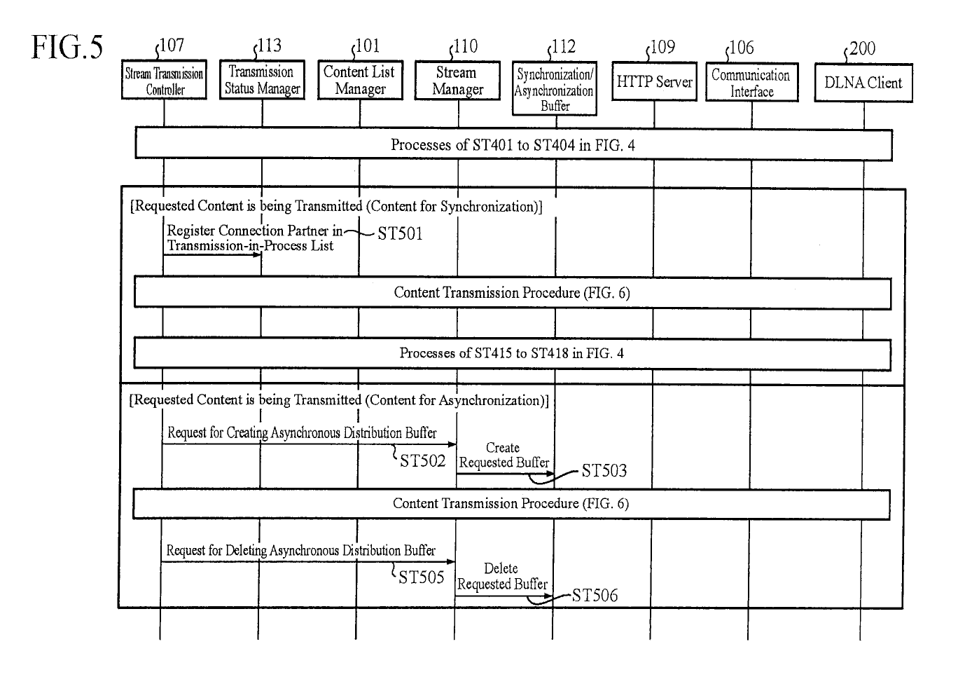

The stream transmission controller 107 requests the synchronous transmission controller 108 to add the DLNA client 200, being the transmission source of the HTTP request, as a synchronous transmission target (FIG. 5, step ST501). At this time, the connection information at the time of acceptance of the HTTP request from the DLNA client 200 is designated.

### (1) In a Case of a Content for Asynchronization

The stream transmission controller 107 requests the stream manager 110 to generate an asynchronization buffer 112 for buffering the content requested by the DLNA client 200 (FIG. 5, step ST502).

Subsequently, the transmission of a stream toward the DLNA client 200 is started. With respect to the present process, description is given in “Stream transmitting process” in “Procedure 4” to be described later.

Upon completion of transmitting of the stream, the stream transmission controller 107 requests the stream manager 110 to delete the asynchronization buffer 112 (FIG. 5, step ST505), and thus the asynchronization buffer 112 is deleted (FIG. 5, step ST506).

### (Procedure 4) Stream Transmitting Process

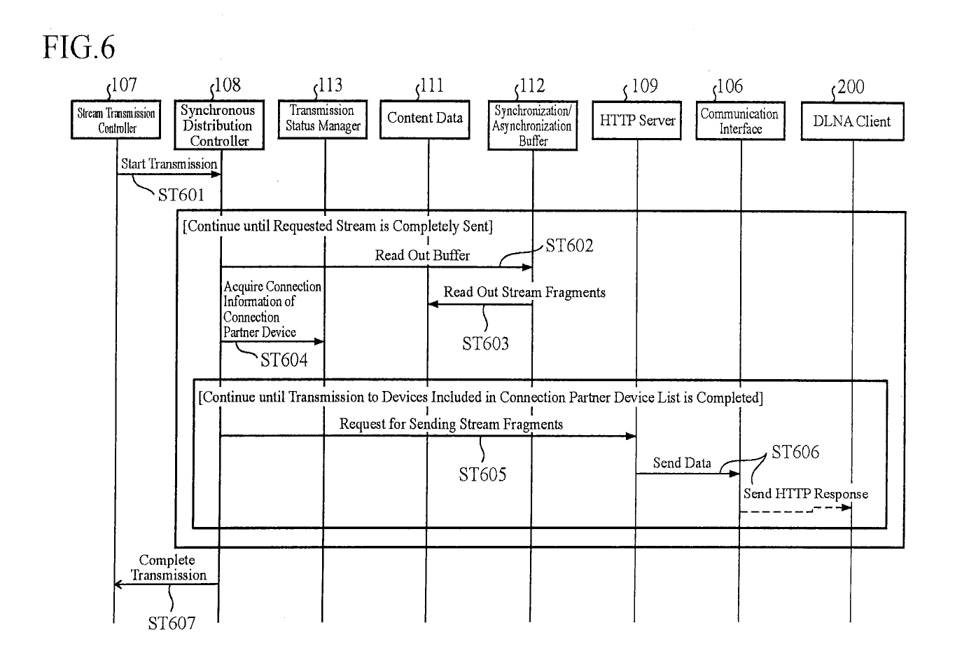

The stream transmission controller 107 requests the synchronous transmission controller 108 to start transmission of the content to the DLNA client 200 which has made the request for the content stream (FIG. 6, step ST601). At this time, the aforementioned content identifier is designated. The synchronous transmission controller 108 continues the following processes (a) to (e) until the stream is completely transmitted.

(a) The synchronous transmission controller 108 performs readout the synchronization/asynchronization buffer 112 (FIG. 6, step ST602).

(b) Fragments of the stream of a certain size are read out from the content data 111 and stored in the synchronization/asynchronization buffer 112 (FIG. 6, step ST603). The content data 111 is managed such that data to be the substance of a content is accumulated and correlated with a content identifier. As the content identifier, a content identifier having been designated for the synchronous transmission controller 108 at a beginning of content transmission by the stream transmission controller 107 is used.

(c) The synchronous transmission controller 108 acquires from the transmission status manager 113 connection information of each connection device registered as destinations of transmission of the content to be replayed (FIG. 6, step ST604). Even if connection devices are renewed halfway due to additional connection or disruption, it can be followed by updating partner devices to which the transmission is to be performed prior to the data transmission.

(d) The synchronous transmission controller 108 requests the HTTP server 109 to transmit the stream fragments (FIG. 6, step ST605).

(e) The HTTP server 109 sends an HTTP response message containing the stream fragments to the DLNA client 200 by using the communication interface 106 (FIG. 6, step ST606). At this time, when transmission requests with respect to a plurality of connection destinations are made, the HTTP server 109 divides the data by a certain size and transmits the divided data in parallel. This process is continued until the stream fragments read out by the processes (a) and (b) are entirely transmitted to each connection partner device. The completion of transmission is recognized by, for example, detecting an ACK packet of TCP/IP.

The synchronous transmission controller 108 notifies the stream transmission controller 107 of the completion of transmission when the stream is entirely transmitted (FIG. 6, step ST607).

As described above, with the synchronous transmission server 100 according to the Embodiment 1, the following advantages can be obtained.

The synchronous transmission server 100 achieves synchronous transmission within the scope of the existing DLNA standards by dynamically adding and deleting contents for synchronization to and from lists in response to requests from DLNA clients 200.

In the existing DLNA standards, a replay is performed in such a manner that a content desired by a DLNA client is chosen from a content list to be transmitted from a DLNA server, and that the stream is sent and received. The present embodiment does not depart from the operation defined by this standard. More specifically, with regard to one content, a plurality of contents according to the transmission methods (i.e. synchronization/asynchronization) are registered in the content list. By this, it is possible to select a transmission method within the scope of the existing DLNA standards.

Selection between synchronization and asynchronization is executable through the same procedure for replay as defined by the existing DLNA standards, i.e., selection and replay of a DLNA server content, at the end of DLNA clients 200. Therefore, alteration is not needed for the existing DLNA clients. More specifically, since the synchronous transmission server 100 suggests an identical content to DLNA clients 200 as different contents of respective synchronization/asynchronization, the DLNA clients 200 are able to work by the same replay method as in the conventional.

The DLNA clients 200 are not needed to perform procedures exclusive for synchronization replay, and have only to simply perform data reception and replay control (data transfer to a decoder) as in the conventional.

### Embodiment 2

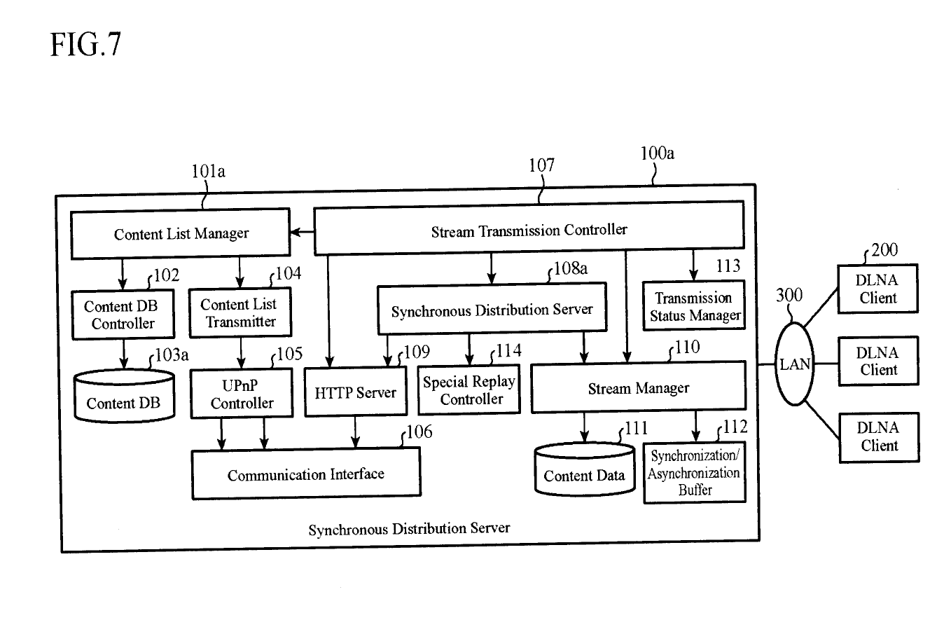

Embodiment 2 corresponds to a special reply (e.g. a time-specified seek or a byte-specified seek) in DLNA. FIG. 7 depicts a configuration of a synchronous transmission system according to the Embodiment 2.

A synchronous transmission server 100a according to the Embodiment 2 includes a content list manager 101a, the content DB controller 102, a content database 103a, the content list transmitter 104, the UPnP controller 105, the communication interface 106, the stream transmission controller 107, the synchronous transmission controller 108, the HTTP server 109, the stream manager 110, the content data 111, the synchronization/asynchronization buffer 112, the transmission status manager 113, and a special replay controller 114.

The special replay controller 114 is configured to perform control relating to special replay in the synchronous transmission server 100a, and operates, the same as existing DLNA supporting devices, to deliver to the synchronous transmission controller 108a a decision as to the range of a stream to be read out, based on seek headers contained in an HTTP request message obtained from the HTTP server 109. The content list manager 101a has a function of, in addition to the function of the content list manager 101 of the Embodiment 1, acquiring attribute information of contents from the content DB controller 102 and inserting availability of time-specified seek and byte-specified seek into the attribute information of each content. The content database 103a adds a flag indicating availability of each of time-specified seek and byte-specified seek to the attribute information of each content. The synchronous transmission controller 108a is configured, in addition to the function of the synchronous transmission controller 108 of the Embodiment 1, to read out the range of stream obtained by the special replay controller 114 to the synchronization/asynchronization buffer 112, and send the readout range of stream to DLNA clients 200. Further, the information on the availability of seeks is likewise included in HTTP response message headers according to the DLNA standards. Since the other configuration is the same as that of the Embodiment 1, like reference numerals are assigned to the corresponding parts and description thereof is not redundantly given.

In the synchronous transmission system according to the Embodiment 2, when a request for the special reply is made from the DLNA client 200, the special replay controller 114 decides the range of stream to be read out based on each seek header contained in the HTTP request message obtained from the HTTP server 109 and delivers the decision to the synchronous transmission controller 108a. Subsequently, the synchronous transmission controller 108a reads out, into the synchronization/asynchronization buffer 112, fragments of the content data 111 in the range of the stream to be read out and sends the fragments to the DLNA client 200. Although it is obvious, when a seek is received from the DLNA client 200, the position of the stream to be sent is changed. Thus, the replay position is changed synchronously across the devices to which the identical content is synchronously transmitted.

As described above, in the synchronous transmission server according to the Embodiment 2, the special replay controller 114 is provided for controlling special replay of content streams. When a request for special replay is made by any DLNA client 200, the special replay controller 114 performs control of the requested special replay. Thus, in addition to the advantages of the Embodiment 1, special replay (e.g. time-specified seek and/or byte-specified seek) can be executed by the DLNA clients 200.

### Embodiment 3

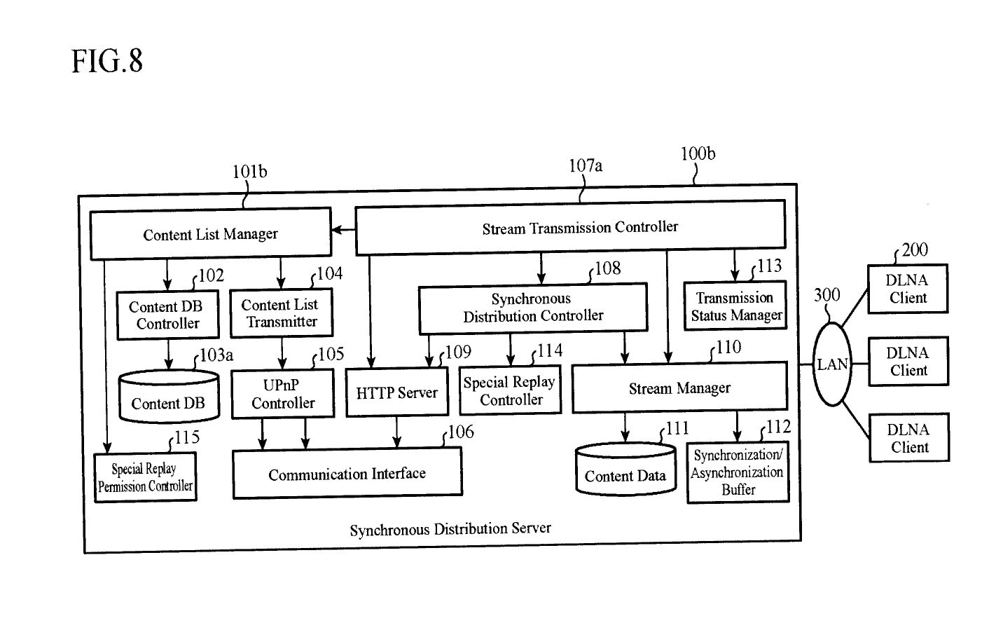

According to the Embodiment 2 described above, special operation from any of the DLNA clients that are replaying the identical content is accepted. According to Embodiment 3, a special replay permission controller 115 is added in order to limit the operable DLNA clients being permitted for the operation of the special replay. A configuration of a synchronous transmission system according to the Embodiment 3 is depicted in FIG. 8.

A synchronous transmission server 100b depicted in FIG. 8 includes a content list manager 101b, the content DB controller 102, the content database 103a, the content list transmitter 104, the UPnP controller 105, the communication interface 106, a stream transmission controller 107a, the synchronous transmission controller 108a, the HTTP server 109, the stream manager 110, the content data 111, the synchronization/asynchronization buffer 112, the transmission status manager 113, the special replay controller 114, and the special replay permission controller 115.

The special replay permission controller 115 is configured to decide a DLNA client 200 to which permission for special replay is given according to a certain rule. The content list manager 101b is configured, in addition to the function of the content list manager 101a of the Embodiment 2, to include availability of a seek to a content list in generating the content list and manage the generated list, only when the seek is executable for the content and this content is permitted by the special replay permission controller 115 for seeking. The stream transmission controller 107a has, in addition to the function of the stream transmission controller 107 of the Embodiment 1, a function of inserting information about availability of a seek into an HTTP response message header based on the attribute information of the content obtained from the content list manager 101b. Since the other configuration is the same as that of the Embodiment 2, like reference numerals are assigned to the corresponding parts and description thereof is not redundantly given.

In the synchronous transmission server 100b of the Embodiment 3, the special replay permission controller 115 decides a device to which permission for special replay is given according to, for example, the following rules:

The device which first replayed the content being synchronously transmitted

The device which matches a MAC address

The device which matches an IP address

The device which matches a device name of UPnP

The content list manager 101b accepts a request for acquisition of a content list from a DLNA client 200, and, when inserting the information about availability of a seek in a content list, acquires availability of special replay from the special replay permission controller 115. Then, when generating the content list, the availability of a seek is included in the content list only when the seek is executable for the content and the seek of the content is permitted. The content list manager 101b specifies information about connection to a partnering DLNA client 200 and thus provides the attribute information of the content including the availability of seek with respect to the partnering DLNA client 200.

The stream transmission controller 107a inserts the information about the availability of seek into an HTTP response message header based on the attribute information of the content obtained from the content list manager 101b.

As described above, the synchronous transmission server of the Embodiment 3 comprises the special replay permission controller 115 that manages the DLNA clients 200 to which permission for special replay is given. Therefore, the request for special replay achieved in the Embodiment 2 is limited to a particular DLNA client 200, obviating simultaneous operation being rendered by a plurality of DLNA clients 200.

### Embodiment 4

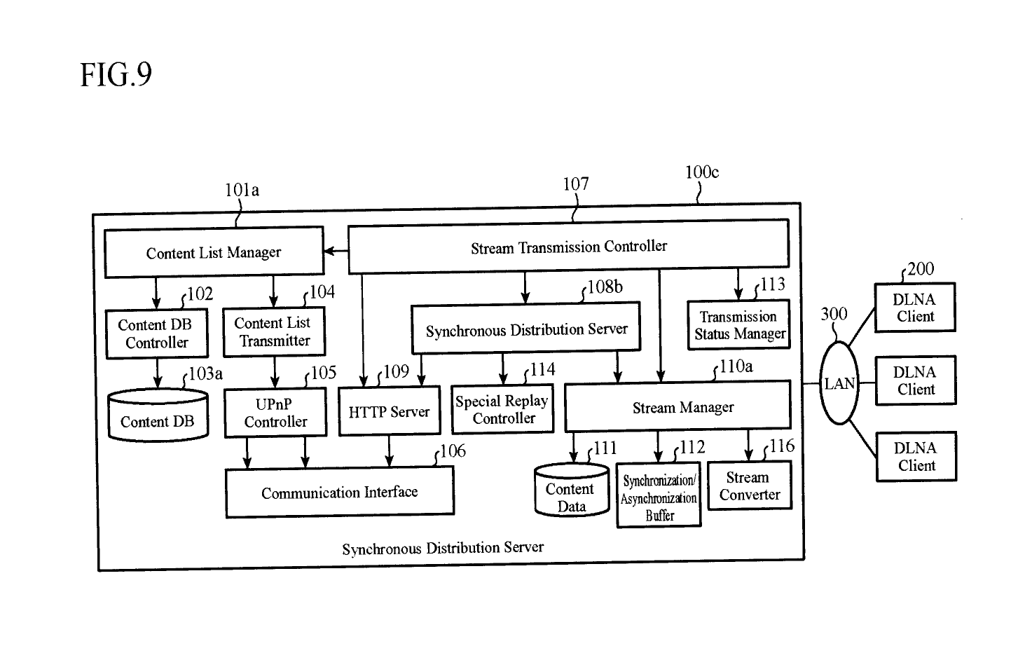

In the Embodiment 2, fragments of a stream are transmitted to a DLNA client during special replay (for example, when a replay is performed at double speed (×2), a stream for one second is transmitted at every one interval). However, depending on the format of the stream, information required for replay, e.g., time information inserted in the stream, may be lost. Thus, the DLNA client 200 may not be able to perform replay appropriately in some cases. Hence, according to Embodiment 4, a stream converter 116 is provided as depicted in FIG. 9.

As depicted in FIG. 9, a synchronous transmission server 100c of the Embodiment 4 includes the content list manager 101a, the content DB controller 102, the content database 103a, the content list transmitter 104, the UPnP controller 105, the communication interface 106, the stream transmission controller 107, a synchronous transmission controller 108b, the HTTP server 109, a stream manager 110a, the content data 111, the synchronization/asynchronization buffer 112, the transmission status manager 113, the special replay controller 114, and the stream converter 116. Since the configuration other than the synchronous transmission controller 108b, the stream manager 110a, and the stream converter 116 is the same as that of the Embodiment 2 depicted in FIG. 7, like reference numerals are assigned to the corresponding parts and description thereof is not redundantly given.

The stream converter 116 transcodes the stream fragments into a format decodable by the DLNA clients 200. For example, in a case of a content formatted in MPEG2-TS, time information such as PCR is extracted and is rewritten to an appropriate value, followed by re-multiplexing. The synchronous transmission controller 108b reads out data of the stream fragments into the synchronization/asynchronization buffer 112, and requests the stream converter 116 through the stream manager 110a to transcode the data.

As format conversion performed at the stream converter 116, not only time information but also attachment information of the stream (attribute information used for replay that is contained in the stream), which is defined in a media format supported by DLNA, may be rewritten. For example, in the case of MPEG2-TS, the format conversion is such that information of a sequence header is included.

As described above, in the synchronous transmission server of the Embodiment 4, the stream converter 116 is provided for combining stream fragments at the time of special replay and performing format conversion. Thus, during special replay of a stream from the synchronous transmission server 100c, a failure in replaying stream fragments in a DLNA client 200 is restrained.

### Embodiment 5

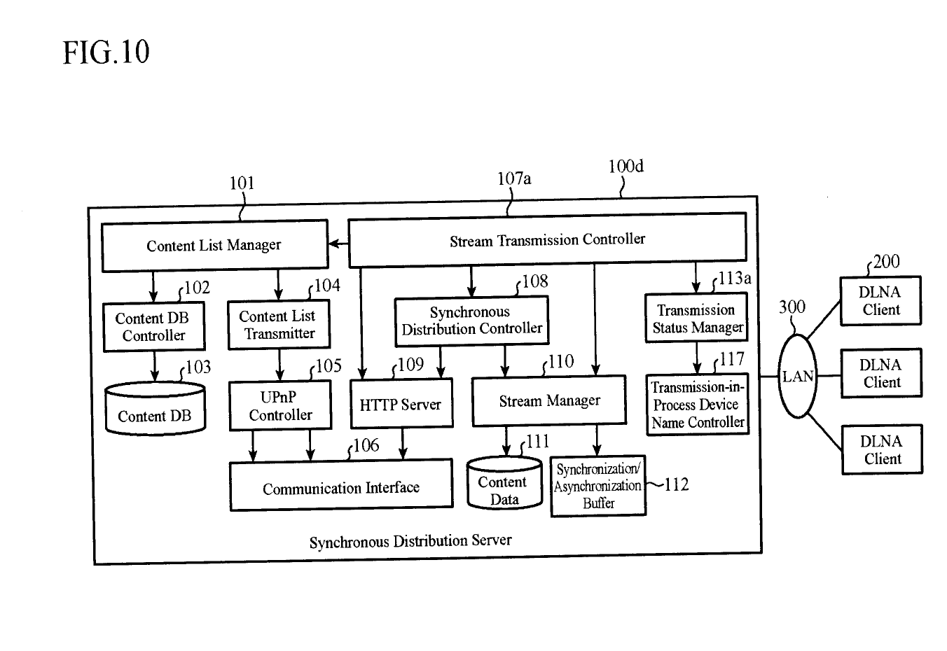

According to Embodiment 5, as depicted in FIG. 10, a transmission-in-process device name controller 117 is added besides the configuration of the synchronous transmission server 100 of the Embodiment 1, so as to add a device name to the content name of a content for synchronous transmission to be added to a content list.

A synchronous transmission server 100d depicted in FIG. 10 includes the content list manager 101, the content DB controller 102, the content database 103, the content list transmitter 104, the UPnP controller 105, the communication interface 106, the stream transmission controller 107a, the synchronous transmission controller 108, the HTTP server 109, the stream manager 110, the content data 111, the synchronization/asynchronization buffer 112, a transmission status manager 113a, and the transmission-in-process device name controller 117. Since the configuration other than the stream transmission controller 107a, the transmission status manager 113a, and the transmission-in-process device name controller 117 is the same as that of the Embodiment 1 as depicted in FIG. 1, like reference numerals are assigned to the corresponding parts and description thereof is not redundantly given.

The stream transmission controller 107a is configured, in addition to the function of the stream transmission controller 107 of the Embodiment 1, to acquire a name list of devices to which transmission is in process by using the transmission status manager 113a. The stream transmission controller 107a is configured, in addition to the function of the stream transmission controller 107 of the Embodiment 1, to add the name of a connection device included in the name list subsequent to the character string comprising the content title (dc:title element) of the attribute information of the content, which character string is created when a content for synchronization is added to the content list manager 101.

If the number of characters for dc:title element that is defined in the DLNA standards is exceeded when adding the name of the connection device, the device name is abridged within the maximum length for the number of characters according to the following priority:

(1) The name of the connection device to which the transmission is first started

(2) A character string contained in the attribute information of the content

(3) Names of connection devices after the first one

The name of a connection device is a character string of, for example, the MAC address or IP address of a DLNA client 200, or a Server header value contained in an HTTP request message.

As described above, in the synchronous transmission server of the Embodiment 5, the transmission-in-process device name controller 117 is provided for managing information for identifying DLNA clients 200 to which transmission is in process as the name of a content for synchronization. Thus, DLNA clients 200 are informed prior to start of replay as to which device the content is being transmitted to, and replay an identical content with the particular device. In other words, synchronization replay with a particular device is selectable at the end of DLNA clients 200.

It should be appreciated that the invention of the present application allows free combination of the embodiments or modification of any components of the embodiments, or omission of any components in the embodiments.

The synchronous transmission server according to the present invention is suitable for use in synchronous transmission from a DLNA server device to DLNA client devices.

100, 100a, 100b, 100c, 100d Synchronous transmission server; 101, 101a, 101b Content list manager; 102 Content DB controller; 103, 103a Content database; 104 Content list transmitter; 105 UPnP controller; 106 Communication interface; 107, 107a Stream transmission controller; 108, 108a, 108b Synchronous transmission controller; 109 HTTP server; 110, 110a Stream manager; 111 Content data; 112 Synchronization/asynchronization buffer; 113, 113a Transmission status manager; 114 Special replay controller; 115 Special replay permission controller; 116 Stream converter; 117 Transmission-in-process device name controller; 200 DLNA client; 300 LAN

1. A synchronous transmission server which communicates with a Digital Living Network Alliance (DLNA) client in compliance with DLNA standards, the synchronous transmission server comprising:
a content list manager that manages a list of contents to be transmitted to the DLNA client as a content list;
a stream transmission controller that transmits a content stream in response to a request from the DLNA client for the content stream; and
a transmission status manager that manages the content being transmitted and the DLNA client of a transmission destination by correlating with each other,
wherein, when the stream transmission controller receives the request from the DLNA client for the content stream and the transmission status manager recognizes that the requested content stream is not being transmitted to another DLNA client, the content list manager registers the requested content stream into the content list as a content for synchronization.

2. The synchronous transmission server according to claim 1, further comprising a special replay controller that controls special replay of the content stream,
wherein, when a request is made by any DLNA client for a special replay, the special replay controller performs control of the requested special replay.

3. The synchronous transmission server according to claim 2, further comprising a special replay permission controller that manages a DLNA client to which permission for the special replay is given.

4. The synchronous transmission server according to claim 2, further comprising a stream converter that combines fragments of a stream for the special replay to convert a format of the fragments.

5. The synchronous transmission server according to claim 1, further comprising a transmission-in-process device name controller that manages, as a name of the content for synchronization, information for identifying the DLNA client to which the content stream is being transmitted.
